(19) United States
(12) Patent Application Publication
(10) Pub. No.: US 2017/0162168 A1
(43) Pub. Date: Jun. 8, 2017

(54) ADAPTIVE INSTRUMENT CLUSTER

(71) Applicant: Freescale Semiconductor, Inc., Austin, TX (US)

(72) Inventors: Victor Hugo Osornio Lopez, Zapopan (MX); Rafal Malewski, Storvorde (DK); Cesar Alejandro Montero Orozco, Austin, TX (US)

(21) Appl. No.: 14/956,930

(22) Filed: Dec. 2, 2015

(51) Int. Cl. G09G 5/00; B60K 35/00; G06K 9/00

(52) U.S. Cl. CPC G09G 5/006; G06K 9/00604; B60K 35/00; G09G 2354/00; G09G 2380/10; B60K 2350/106; B60K 2350/2065; B60K 2350/962

(57) ABSTRACT

An adaptive instrument cluster (AIC) is employed in a device, such as an automobile, wherein the AIC adjusts a display of instrumentation information based on one or more of captured imagery, user eye position, and device conditions. Based on these factors the AIC can adjust the appearance, position, information display format, and other aspects of one or more instrument gauges. By adjusting the instrument gauges based on these factors, the adaptive instrument cluster is able to conveniently and effectively communicate instrumentation information to a device user.

### BACKGROUND

Field of the Disclosure

The present disclosure relates generally to instrument clusters and more particularly to programmable instrument clusters.

Description of the Related Art

Many devices employ an instrument cluster to provide instrumentation information to a device user. For example, an automobile typically includes an instrument cluster with a speedometer, tachometer, fuel gauge, and warning indicators to notify the driver of any issues with the automobile's operation. Historically, instrument clusters have employed analog gauges that are mechanically coupled to one or more device sensors. As the sensors generate instrumentation information, the information is displayed on the analog gauges. More recently some devices have employed electronic or digital instrument clusters that display the instrumentation information digitally. However, such analog and digital instrument clusters are fixed displays, resulting in an unsatisfying user experience, and such instrument clusters may also present information to the user that is not useful.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a device employing an adaptive instrument cluster that can adjust the format of displayed instrumentation information based on captured imagery and on device conditions in accordance with at least one embodiment of the present disclosure.

FIG. 2 is a block diagram illustrating a processing module of the adaptive instrument cluster of FIG. 1 in accordance with at least one embodiment of the present disclosure.

FIG. 3 is a diagram illustrating an example operation of the adaptive instrument cluster of FIG. 1 to adjust display of an instrument gauge based on captured imagery in accordance with at least one embodiment of the present disclosure.

FIG. 4 is a diagram illustrating an example operation of the adaptive instrument cluster of FIG. 1 to adjust display of an instrument gauge based on detected user eye position in accordance with at least one embodiment of the present disclosure.

FIG. 5 is a diagram illustrating an example operation of the adaptive instrument cluster of FIG. 1 to adjust display of an instrument gauge based on device conditions in accordance with at least one embodiment of the present disclosure.

FIG. 6 is a diagram illustrating an example operation of the adaptive instrument cluster of FIG. 1 to adjust display of an instrument gauge based on a detected eye position indicative of a user's field of view in accordance with at least one embodiment of the present disclosure

### DETAILED DESCRIPTION

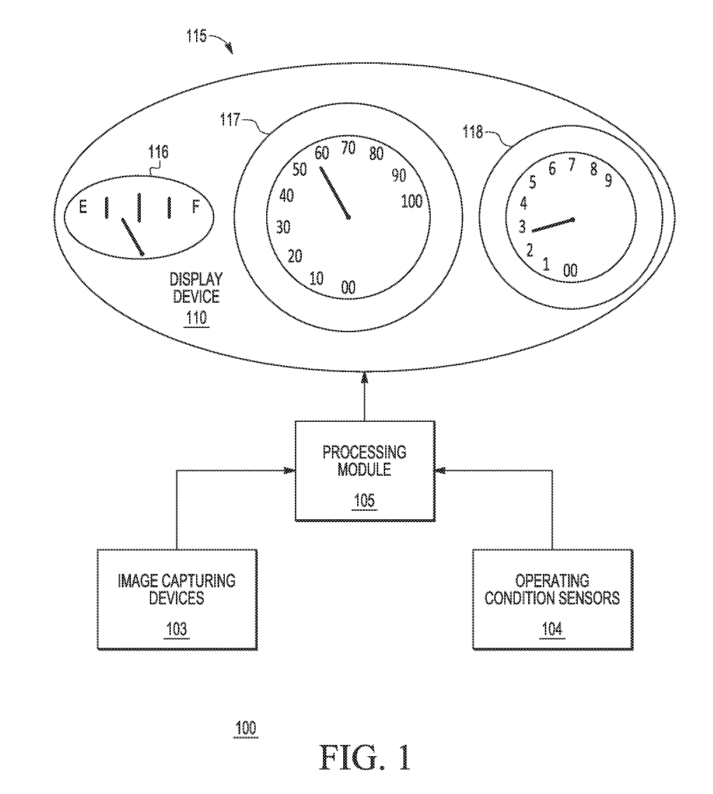

FIGS. 1-6 illustrate techniques for employing an adaptive instrument cluster (AIC) in a device, such as an automobile, wherein the AIC adjusts a display of instrumentation information based on one or more of captured imagery, user eye position, and device conditions. For example, based on these factors the AIC can adjust the appearance, position, information display format, and other aspects of one or more instrument gauges. By adjusting the instrument gauges based on these factors, the adaptive instrument cluster is able to conveniently and effectively communicate instrumentation information to a device user, resulting in an improved user experience relative to conventional instrument clusters.

To illustrate via an example, in at least one embodiment the AIC captures imagery in the surrounding environment of an automobile, including imagery external to the automobile and internal imagery of an automobile cabin. Based on this captured imagery the AIC can generate an image map of the automobile environment. The AIC can employ this image map to simulate the display of one or more user selected materials, so that the displayed instrument gauges, or aspects thereof, appear to a user to be made of the selected materials. Moreover, as device conditions change, such as the ambient light in the automobile environment, the AIC can further adjust the instrument gauges to increase the contrast between displayed instrumentation information and the selected materials, thereby improving the communication of instrumentation information to the user.

As another example, in at least one embodiment the AIC can employ the captured imagery or other sensor information to identify an eye position for the user. Based on the identified eye position, the AIC can adjust the displayed instrumentation gauges to ensure that instrumentation information is effectively and conveniently communicated to the user. For example, the AIC can adjust the position of one or more instrumentation gauges based on the user eye position to ensure that the gauges are maintained in the user's field of view. The AIC can also change the format of the instrumentation gauges based on the user eye position so that, for example, if the user is not looking directly at the instrument cluster, only selected instrumentation information is displayed, and is displayed in a simplified format. The AIC thereby communicates important instrumentation information to the user more effectively.

As yet another example, in at least one embodiment the AIC can adjust the displayed instrument cluster based on device conditions, as indicated by the captured imagery and other device sensors. For example, if the AIC identifies that the automobile is executing a turn, it can adjust the position of one or more instrument gauges to ensure that the gauges remain within the user's field of view. As another example, if the AIC identifies a device malfunction it can adjust the size, position, or other visual characteristic of a corresponding malfunction icon to ensure that the icon is likely to be visible to the user. Using these techniques, the AIC is able to effectively communicate instrumentation information to the user under a wide variety of device conditions.

FIG. 1 illustrates a block diagram of an automobile including an AIC 100 in accordance with at least one embodiment of the present disclosure. Although the example of FIG. 1 is described in the context of an automobile, it will be appreciated that the techniques described herein can be implemented in any device that employs an instrument cluster, including vehicles, industrial and manufacturing equipment and machinery, and the like. In the depicted example, the AIC 100 includes imaging capturing devices 103, operating condition sensors 104, a processing module 105, and a display device 110 to display an instrument cluster 115 including a set of instrumentation gauges (e.g. instrumentation gauge 116).

The image capturing devices 103 include one or more cameras or other image capturing devices to capture imagery in an environment of the automobile. In at least one embodiment, the image capturing devices 103 include an external set of cameras to capture images of the external environment of the automobile and an internal set of cameras to capture an internal cabin or other environment of the automobile. For example, the external set of cameras can include multiple cameras arrayed along a frame of the automobile, with the respective camera apertures positioned so that the external set of cameras collectively captures images sufficient to reflect a 360 degree view of the environment around the automobile. Similarly, the internal set of cameras can include cameras arrayed in the internal cabin of the automobile and positioned so that the internal set of cameras collectively captures images sufficient to reflect a view of the entire cabin.

The operating condition sensors 104 include one or more sensors to sense operating conditions of the automobile, including aspects of motion such as speed, acceleration, and direction, ambient conditions such as the external temperature of the automobile and the ambient light of the surrounding environment, and the like. The operating condition sensors 104 can also include automobile sensors for different aspects of device operation, such as tire pressure sensors, seat belt operation sensors, engine operation sensors (e.g., engine temperature sensors), and the like.

The processing module 105 includes one or more processing units, such as one or more central processing unit (CPU) cores, graphics processing unit (GPU) cores, and the like, as well as hardware to support processing operations by the processing units, including memory and memory interfaces, input/output interfaces, and the like. The processing module 105 is generally configured to execute sets of instructions to receive and process captured imagery from the image capturing devices 103 and sensor information the operating conditions sensors 104. Based on the captured imagery and the sensor information, the processing module 105 generates and adjusts the display of the instrument cluster 115, as described further herein. For example, based on the captured imagery and the sensor information the processing module 105 can adjust the appearance, display format, position, and the like, of one or more instrument gauges of the instrument cluster 115. The processing module 105 thereby adapts the instrument cluster 115 based on one or more of the visual surroundings of the automobile, the motion of the automobile, errors in operation of the automobile (including user errors and mechanical or electronic failures), eye position of the automobile driver, and the like.

The display device 110 is a device configured to display frames of information provided by the processing module 105. Accordingly, the display device 110 can be any form of electronic display, such as an organic light-emitting diode (OLED) display, active-matrix organic light-emitting diode (AMOLED) display, liquid crystal diode (LCD) display, and the like. The display device 110 displays the frames of information and thereby generates the instrument cluster 115 including instrument gauges 116, 117 and 118. In the illustrated example of FIG. 1, instrument gauge 116 is a fuel indicator, instrument gauge 117 is a speedometer, and instrument gauge 118 is a tachometer. It will be appreciated that the depicted instrument cluster 115 is only an example, and that the instrument cluster 115 may include different instrument gauges, and that the instrument gauges of the instrument cluster 115 may change based on operating conditions of the automobile, as described further herein. Further, as used herein an instrument gauge may be a gauge that displays a numerical value, as in the case of the speedometer 117, a gauge that indicates a relative amount, as in the case of the fuel gauge 116, and may be a gauge that indicates the presence or absence of a particular detected condition, such as low tire pressure, absence of seatbelt engagement, and the like. In other words, the gauges of the instrument cluster 115 may include warning lights and other sensor indicators found in an automobile.

In operation, the processing module 105 generates the instrument cluster 115 by identifying operating conditions of the automobile based on the sensor information generated by the operating condition sensors 104. Based on these operating conditions, the processing module 105 generates display frames including the instrument gauges of the instrument cluster 115 so that the gauges reflect the corresponding operating condition, such as fuel level, speed, and wheel revolutions-per-minute (RPM). The processing module 105 provides the display frames to the display device 110 for display. As the operating conditions change, the processing module 105 changes the display of the instrument gauges so that the instrument gauges reflect current operating conditions of the automobile. For example, as the speed of the automobile changes, the processing module 105 changes the display frames so that the speedometer 117 reflects the current speed of the automobile.

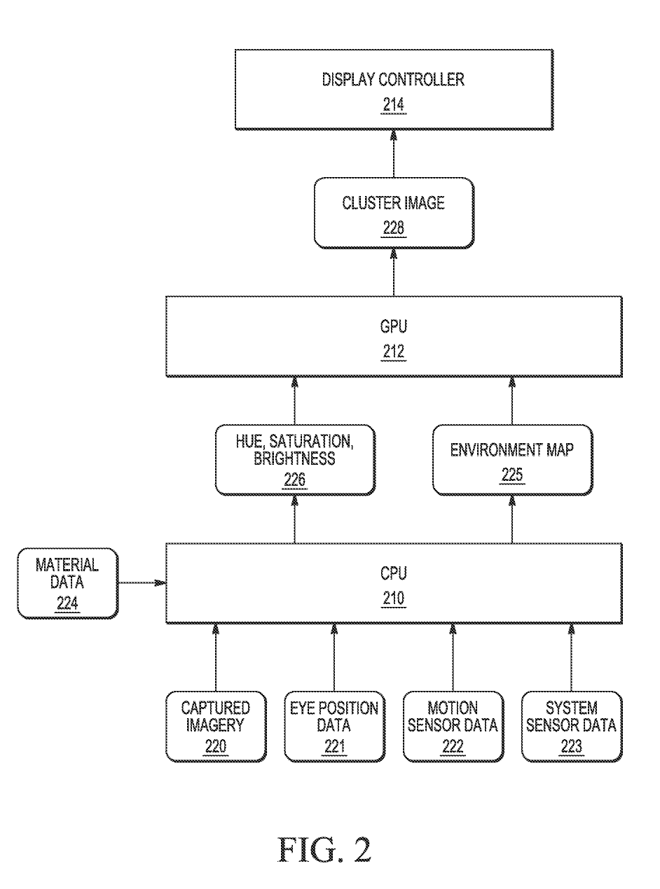

In addition to updating the instrument cluster 115 so that the instrument gauges reflect the current operating conditions of the automobile, the processing module 105 can adapt one or more aspects of the instrument cluster 115 based on imagery captured by the image capture devices 103 and on operating conditions indicated by the operating condition sensors 104. For example, based on this information the processing module 105 can adjust one or more of the types and number of instrument gauges that are displayed, the position of the instrument gauges in the instrument cluster 115, the appearance of one or more aspects of the instrument gauges, the format of the information displayed by the instrument gauges (e.g., whether an instrument gauge displays information via a digital number or via a simulated analog dial), and the like. Additional aspects of the operation of the processing module 105 to adapt the display of the instrument cluster 115 can be further understood with reference to FIG. 2.

FIG. 2 illustrates aspects of the processing module 105 of FIG. 1 in accordance with at least one embodiment. In the depicted example, the processing module 105 includes a CPU 210, a GPU 212, and a display controller 218. The CPU 210 is a processing unit generally configured to execute sets of instructions to carry out general-purpose operations for the processing module 105, such as receiving and processing sensor information and captured imagery, memory and I/O management, thread management, and the like. The GPU 212 is a processing unit generally configured to carry out graphics and image processing operations for the processing module 105, including generating frames of the instrument cluster 115 (e.g., cluster image frame 228) for display at the display device 110 (FIG. 1). The display controller 218 is a module configured to receive cluster image frames from the GPU 212 and render those frames for display at the display device 110.

In operation, the CPU 210 receives a variety of information from the image capture devices 103 and operating condition sensors 104. For example, the CPU 210 can receive captured imagery 220, representing imagery captured by the image capture devices 103; eye position data 221, representing data indicative of an eye position of a driver of the automobile; motion sensor data 222, representing data generated by one or more accelerometers or other motion sensing devices and indicating aspects of motion of the automobile, such as speed, acceleration, and direction of motion; and system sensor data 223, indicating detected operating conditions at one or more portions of the automobile, such as tire pressure, engine temperature, automotive fluid levels, seatbelt activation, and the like. Based on this received information, the CPU 210 identifies the data to be displayed by the instrument cluster 115. In addition, the CPU 210 identifies a baseline format for the instrument cluster 115, indicating the instrument gauges that are to be displayed at the instrument cluster 115 under a set of baseline conditions (e.g., when the automobile is started and motionless), the format for each gauge to be displayed, and the like. In at least one embodiment, the baseline format can be adjusted by a user through a graphical user interface of the automobile, via a smartphone application or other remote interface, via a user provided configuration file, and the like. Based on the data to be displayed and the baseline format for the instrument cluster 115, the CPU 210 generates a set of display parameters and provides the display parameters to the GPU 212. The GPU 212 employs conventional graphics and image generation techniques to generate the cluster image frame 228 based on the display parameters. The image frame 228 thus reflects the instrument cluster 115 in the baseline format, and indicating the respective automobile operating conditions at the corresponding instrument gauges. Thus, for example, the instrument cluster 115 will display the speed of the automobile at the speedometer 117, with the speedometer 117 have the format required by the baseline format. The display controller 214 renders the cluster image frame 228 at the display device 110 so that the instrument cluster 115 is displayed to the automobile driver.

The CPU 210 and GPU 212 are also configured to adapt the display of the instrument cluster based on one or more of the information received by the CPU 210, including based on the captured imagery 220, the eye position data 221, the motion sensor data 222, and the system sensor data 223. For example, the CPU 210 and GPU 212 can adapt the appearance of one or more portions of the instrument cluster 115 so that those portions simulate the appearance of a particular material, such as a type of metal, cloth, and the like. The CPU 210 and GPU 212 can also adapt the format and position of the instrument gauges of the instrument cluster 115 based on the eye position data 221. Further, the CPU 210 and GPU 212 can adapt the format and position of the instrument gauges based on operating conditions of the automobile, such as whether the automobile is turning or proceeding in a generally straight direction. For clarity, each of these aspects will be described individually below. However, it will be appreciated that these aspects can be combined in any of a variety of ways, as well as combined with any other adaptive technique described herein, without departing from the scope of the disclosure.

In at least one embodiment, the CPU 210 and GPU 212 together can adapt the display of one or more portions of the instrument cluster 115 based on the captured imagery 220, so that the one or more portions simulate the appearance of a given type of material in the environment of the instrument cluster (e.g., an automobile interior). To illustrate, the CPU 210 can access material data 224 that indicates a type of material whose appearance is to be emulated at a portion of the instrument cluster 115. For example, the material data 224 can indicate that an outer border of the speedometer 117 (FIG. 1) should appear to be a kind of metal, such as chrome. In at least one embodiment, the material to be emulated by the portion can be selected by the user via a graphical user interface, smartphone application, configuration file, and the like. The material data 224 indicates visual aspects of the selected material, such as reflectivity, specularity, opacity, and the like. The material data 224 thus indicates how the emulated material is expected to interact with an environment map 225, including light intensities, light colors, and other visual characteristics.

The CPU 210 generates the environment map 225 based on the captured imagery 220, so that, for example, the environment map represents the light intensities, light colors, and other visual characteristics of the internal and external environment of the automobile. The environment map 225 can be a cube map, spherical map, or other environment map generated according to conventional environment map techniques. In addition, based on the captured imagery 220, or on environment map 225, the CPU 210 generates hue, saturation, and brightness (HSB) information 226 for the environment of the automobile. In at least one embodiment, the HSB information 226 represents an average hue, saturation, and brightness for the environment.

The GPU 212 uses the material data 224, the environment map 225, and the HSB information 226 to generate the cluster image frame 228 so that the respective portions of the instrument cluster simulate the appearance of the corresponding material. For example, in at least one embodiment the GPU 212 uses conventional raytracing or other image generation techniques so that a portion of the instrument cluster 115 emulates the color, reflectivity, and other visual aspects of the material indicated by the material data 224. Because the GPU 212 employs the environment map 225, which was in turn generated based on the captured imagery 220, the material is emulated based on the actual environment of the automobile. The CPU 210 and GPU 212 therefore emulate the material more accurately, leading to a more natural appearance of the emulated material.

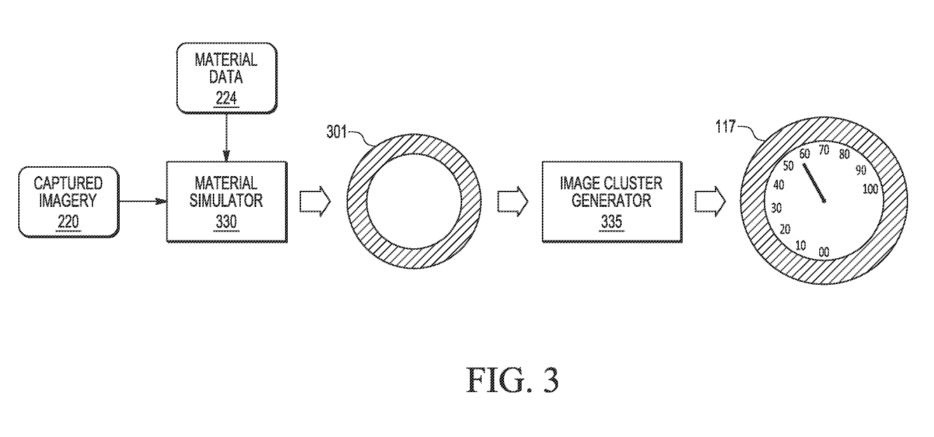

An example of the emulation of a material at the instrument cluster 115 is illustrated at FIG. 3 in accordance with at least one embodiment. For the depicted example, it is assumed that the processing module 105 is to generate the instrument cluster 115 so that a circular border 301 of the speedometer 117 appears to be made of brushed aluminum. To emulate the material, the processing module 105 executes a material simulator 330, representing one or more operations of the CPU 210 and the GPU 212. In particular, the material simulator 330 identifies the reflectivity, opacity, and other visual characteristics of brushed aluminum based on the material data 224. In addition, the material simulator 330 generates the environment map 225 based on the captured imagery 220. The environment map 225 indicates the position, intensity, color, and other aspects of light in the environment of the automobile. Based on this information, the material simulator 330 generates display information for the border 301 so that it emulates brushed aluminum, including emulating reflections of objects in the environment of the automobile, the color of light in the environment as it strikes brushed aluminum, and other visual aspects. For example, the material simulator may use raytracing or other display techniques to identify light sources in the imagery, how rays of light from such light sources are expected to reflect off the emulated material based on their position relative to the material, the color of the reflected light, and other aspects. That is, the border 301 is generated so that it emulates the appearance of brushed aluminum as it would appear if it were located in the environment of the automobile. For example, using the raytracing or other display techniques, the border 301 to have a color, luminosity, and other visual aspects to emulate how rays of light from the identified light sources would reflect off the emulated materials. Further, as the environment of the automobile changes over time, the processing module 105 updates the instrument cluster 115, and in particular the border 301, to continuously reflect the environment of the automobile. The processing module 105 thereby emulates materials at the instrument cluster 115 more accurately, resulting in an improved user experience.

In at least one embodiment, instead of or in addition to employing the captured imagery 220 to emulate materials for display at the instrument cluster 115, the processing module employs the captured imagery 220 to adapt one or more colors of the instrument cluster 115 to increase the contrast of the displayed information with the surrounding environment. To illustrate, the processing module 105 can identify a predominant color in the surrounding environment based on the captured imagery 205. Using a stored color wheel or other contrast identification information, the processing module 105 can identify one or more colors that are known to have high contrast with the predominant color. The processing module 105 can then employ this color for one or more portions of the instrument cluster 115. For example, the processing module 105 can employ the high-contrast color for high-priority alerts, such as indication of serious errors at the automobile, to indicate detection of an emergency vehicle in proximity to the automobile, and the like. Further, as the predominant color of the environment changes, the processing module updates the high-contrast color, thereby ensuring relatively high-visibility for the selected portions of the instrument cluster 115.

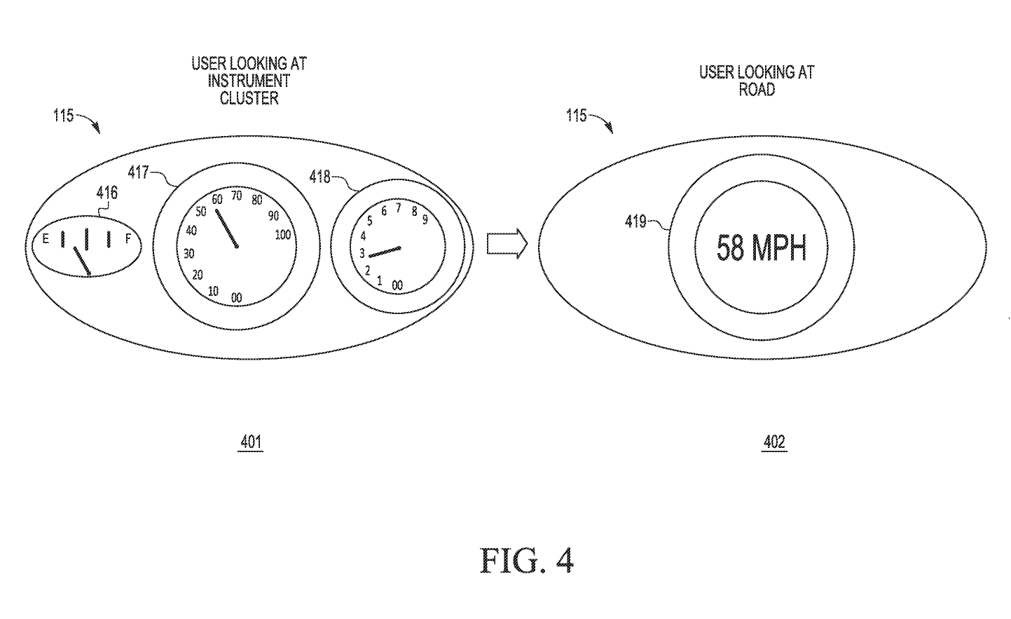

FIG. 4 illustrates an example of the processing module 105 adapting the instrument cluster 115 based on an eye position of the driver of the automobile in accordance with at least one embodiment. In particular, the CPU 102 can receive the eye position data 221 and, based on the data, adjust one or more of which instrument gauges are displayed at the instrument cluster 115, the format of the information displayed by each gauge, the position of each instrument gauge, and the like. In addition, based on the eye position data 221, the processing module 105 can change visual aspects of the displayed gauges to emulate the appearance of particular material, as the appearance of such material can change depending on the user's eye position. In at least one embodiment, the CPU 102 generates the eye position data 221 from the captured imagery 220 using conventional eye-tracking techniques, such as by analyzing the captured imagery to identify the driver's eyes and position in the imagery.

In the example of FIG. 4, at time 401 the processing module 105 determines, based on the eye position data 221, that the driver is looking directly at the instrument cluster, indicating that the driver is seeking relatively detailed information about the state of the automobile. In response, the processing module 105 generates the instrument cluster 115 to include three instrument gauges: a fuel gauge 416, a speedometer 417, and a tachometer 418. In addition, in order to display the amount of fuel, the speed, and the RPMs relative to their respective ranges, the processing module 105 sets the format of the instrument gauges 416-418 to emulate an analog gauge that displays the possible range of values for each type of information and the present instrument value relative to the corresponding range.

At a subsequent time 402, the processing module 105 determines, based on the eye position data 221, that the driver is looking at the road through a front windshield of the automobile. In this scenario, the driver is only able to view the instrument cluster 115 via peripheral vision. Accordingly, the driver is unlikely to be able to effectively read a set of analog gauges in the instrument cluster, as too much information is presented, and is presented in a relatively complex format. Further, the driver is unlikely to need to frequently assess fuel level or RPMs while looking at the road, but is likely to need to assess speed relatively frequently, in order to ensure that a safe and legal speed is maintained. Therefore, in response to determining that the driver is looking at the road, the processing module 105 adapts the instrument cluster 115 so that it is only displaying a speedometer 419, and no longer displays a fuel gauge or a tachometer. Further, the processing module 105 adjusts the display format for the speedometer 419 so that it displays a digital readout of the current speed, rather than emulating an analog gauge. The driver can therefore quickly identify the current speed of the device via peripheral vision. Thus, the processing module 105 adapts the instrument cluster 115 based on eye position of the driver, improving the user experience as well as user safety.

In at least one embodiment, the configuration of the instrument cluster 115 under different conditions is adjustable by the user. For example, the user can set particular configurations of the instruments cluster 115, including gauge types, gauge formats, gauge positions, and the like, for any of a number of different conditions, including different eye positions, operating conditions such as automobile speed, weather, ambient light, or other environmental conditions, and the like. The configurations can be set or selected by a user via a graphical user interface, smartphone application, configuration file, and the like. The user can thereby tailor the instrument cluster 115 according to the particular preferences of the user.

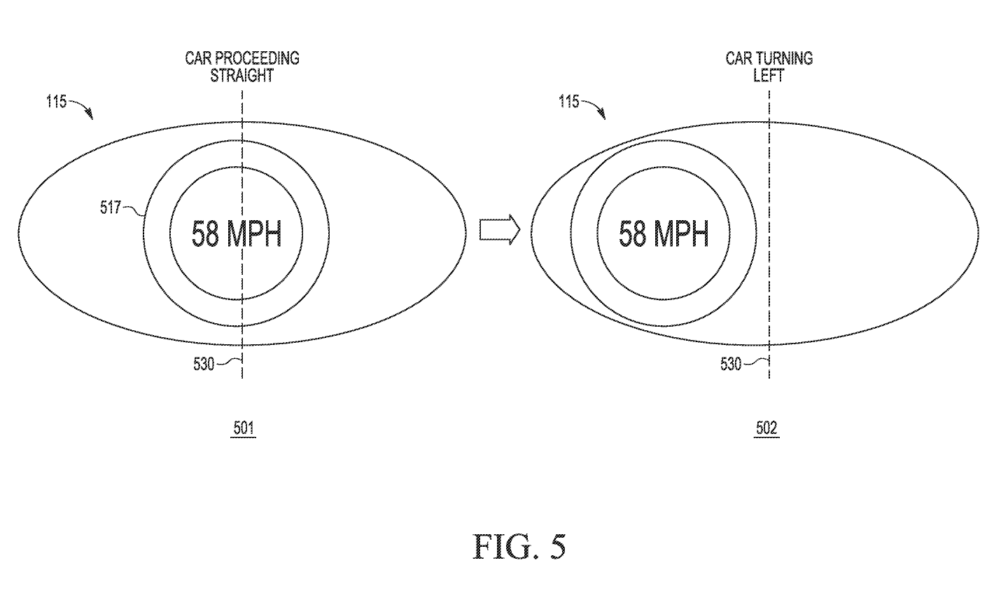

FIG. 5 illustrates an example of the processing module 105 adapting the instrument cluster 115 based on operating conditions of the automobile. In the depicted example, the processing module 105 adjusts the position of a speedometer 517 based on a direction of motion of the automobile. To illustrate, at a time 501 the processing module determines, based on motion sensor data 222 (FIG. 2), that the automobile is proceeding in a generally straight direction. Under these conditions, the driver is likely to be relatively centered with respect to a center axis 530 of the instrument cluster 115. Accordingly, the processing module 105 generates the instrument cluster 115 so that the speedometer 117 is centered around the center axis 530.

At a subsequent time 502, the processing module 105 determines, based on the motion sensor data 222, that the automobile is turning in a leftward direction. Under these conditions, the driver is likely to be leaning in a leftward direction relative to the center axis 530, and therefore the speedometer 517 may move out of the driver's field of vision. Accordingly, in response to determining that the automobile is turning in the leftward direction, the processing module 105 adapts the instrument cluster 115, so that the center of the speedometer 517 is placed to the left of the center axis 530. After the automobile completes the turn, the processing module 105 returns the speedometer 517 to its original centered position. The processing module 105 thereby ensures that the speedometer 117 is maintained within the driver's field of vision as the automobile changes directions.

In at least one embodiment, the processing module 105 can change the content and format of the displayed gauges based on malfunctions or other conditions at the automobile. For example, in response to identifying that a tire of the automobile has low tire pressure, the processing module 105 can display an icon indicating the low tire pressure, wherein a size, color, or other visual aspect of the icon is dependent on whether the user is looking at the instrument cluster 115. Thus, in response to identifying that the user is not looking at the instrument cluster 115, the processing module 105 can display a relatively large icon in a color (e.g., yellow) that is more likely to be noticed by the user. In response to identifying that the user is looking at the instrument cluster 115, the processing module can display a relatively small icon in a different color (e.g., red).

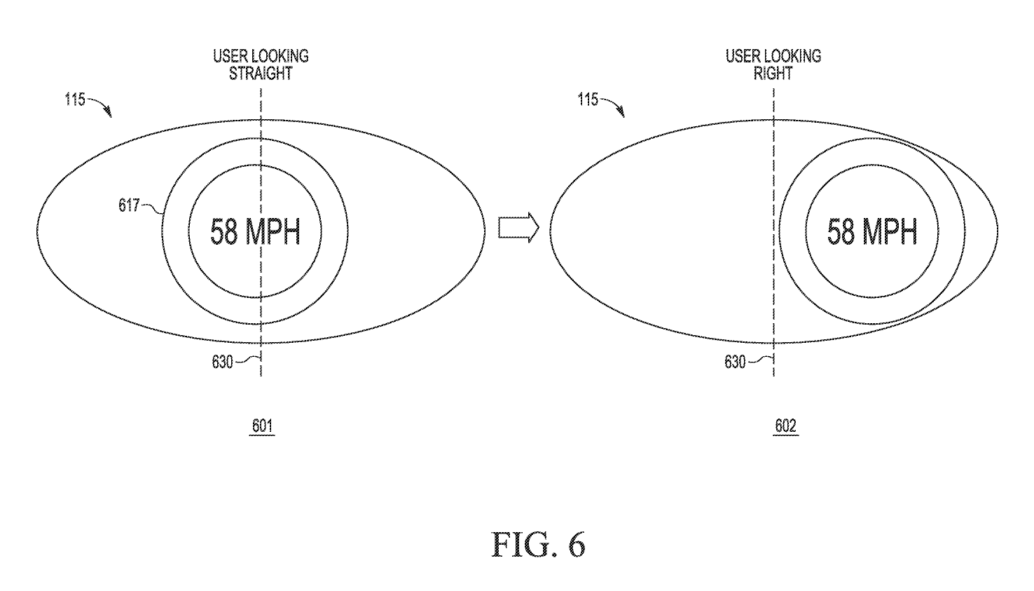

FIG. 6 illustrates an example of the processing module 105 adapting the position of gauges at the instrument cluster 115 based on a detected position of the user's eyes. In the depicted example, the processing module 105 adjusts the position of a speedometer 617 based on a position of the user's eyes. To illustrate, at a time 601 the processing module determines, based on eye position data 221 (FIG. 2), that the automobile is looking in a generally straight direction. Under these conditions, the driver's field of view is likely to be relatively centered with respect to a center axis 630 of the instrument cluster 115. Accordingly, the processing module 105 generates the instrument cluster 115 so that the speedometer 117 is centered around the center axis 630.

At a subsequent time 602, the processing module 105 determines, based on the eye position data 222, that the user is looking in a rightward direction. Under these conditions, the user's field of view is likely to be to the right of the center axis 530, and therefore the speedometer 517 may move out of the driver's field of view. Accordingly, in response to determining that the user is looking in the rightward direction, the processing module 105 adapts the instrument cluster 115, so that the center of the speedometer 617 is placed to the right of the center axis 630. The processing module 105 continues to adapt the position of the the speedometer 617 as the user's field of view changes. The processing module 105 thereby ensures that the speedometer 117 is maintained within the driver's field of vision as the user's eye position changes.

In some embodiments, certain aspects of the techniques described above may implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc , magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

1. A method comprising:
capturing, at an electronic device, imagery in an environment external to an automobile; and
modifying, at the electronic device, a display of one or more of a size and a location of an instrument cluster based on the captured imagery including modifying instrumentation of the instrument cluster.

2. The method of claim 1, further comprising:
identifying at the electronic device an eye position of a user; and
wherein modifying the display of the instrument cluster comprising modifying the display of the instrument cluster based on the eye position.

3. The method of claim 1, wherein modifying wherein modifying the display of the instrument cluster comprising modifying the display of the instrument cluster to emulate an appearance of a physical material based on the captured imagery.

4. The method of claim 3, further comprising:
identifying the physical material at the electronic device based on an adjustable user setting.

5. The method of claim 4, wherein modifying the display of the instrument cluster to emulate the appearance of the physical material comprises:
identifying a reflectivity of the physical material;
modifying the display of the instrument cluster to emulate a reflection of one or more features of the captured imagery based on the reflectivity.

6. The method of claim 1, wherein modifying the display of the instrument cluster comprises:
identifying one or more of a hue, saturation, and brightness from the captured imagery; and
modifying the display of the instrument cluster based on the one or more of the hue, saturation, and brightness.

7. The method of claim 1, further comprising:
identifying an operating condition of the automobile, the operating condition indicating at least one of an aspect of motion of the automobile and an error condition at the automobile; and
wherein modifying the display of the instrument cluster comprises modifying the display of the instrument cluster based upon the operating condition.

8. The method of claim 1, wherein capturing the imagery further comprises capturing at least one image of an internal portion of the automobile.

9. A method, comprising:
identifying one or more operating conditions of an automobile; and
modifying one or more of a size and a location of an instrument cluster of the automobile based on the identified one or more operating conditions to change an appearance of the instrument cluster.

10. (canceled)

11. The method of claim 9, further comprising:
identifying at the automobile an eye position of a user; and
wherein modifying one or more of the size and location of the instrument cluster comprising modifying the format of the instrument cluster based on the eye position.

12. The method of claim 9, wherein identifying the one or more operating conditions comprises identifying one or more of a speed, acceleration, and temperature of the automobile.

13. An electronic device, comprising:
one or more image capturing devices to capture imagery in an environment external to an automobile;
a processor to identify one or more visual characteristics based on the captured imagery; and
a display device to change the display of one or more of a size and a location of an instrument cluster based on the one or more visual characteristics.

14. The electronic device of claim 13, further comprising:
wherein the processor is to identify an eye position of a user; and
wherein the display device is to display the instrument cluster based on the eye position.

15. The electronic device of claim 13, wherein the display device is to display the instrument cluster to emulate an appearance of a physical material based on the one or more visual characteristics.

16. The electronic device of claim 15, wherein the processor is to:
identify the physical material at the electronic device based on an adjustable user setting.

17. The electronic device of claim 16, wherein:
the processor is to identify a reflectivity of the physical material;
the display device is to display the instrument cluster to emulate a reflection of one or more features of the captured imagery based on the reflectivity.

18. The electronic device of claim 13, wherein:
the processor is to identify one or more of a hue, saturation, and brightness from the captured imagery; and
the display device is to display the instrument cluster based on the one or more of the hue, saturation, and brightness.

19. The electronic device of claim 13, further comprising:
one or more sensors to indicate an operating condition of the automobile, the operating condition indicating at least one of an aspect of motion of the automobile and an error condition at the automobile; and
wherein the display device is to display the instrument cluster based upon the operating condition.

20. The electronic device of claim 13, wherein the one or more image capturing devices is further to capture at least one image of an internal portion of the automobile.
